(19) United States
(12) Patent Application Publication
(10) Pub. No.: US 2003/0028458 A1
(43) Pub. Date: Feb. 6, 2003

(54) System and method to accomplish a transaction

(76) Inventor: Joel Gaillard, Nassau (BS)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/256,393

(22) Filed: Sep. 27, 2002

Related U.S. Application Data
(63) Continuation-in-part of application No. PCT/IB01/00354, filed on Mar. 12, 2001.
(60) Provisional application No. 60/238,418, filed on Oct. 10, 2000.
(60) Provisional application No. 60/238,417, filed on Oct. 10, 2000.
(60) Provisional application No. 60/214,436, filed on Jun. 28, 2000.

(51) Int. Cl. G06F 17/60

(52) U.S. Cl. 705/35

(57) ABSTRACT

The method for a transaction at a point of sales through the instrumentality of a personal portable identification and transaction control device PPITCD comprises the following steps:

a) transmitting the amount of the transaction to the PPITCD;

b) indicating the transaction amount through an interface device of the PPITCD;

c) validating the transaction; and

d) applying the transaction at a financial source associated to said PPITCD.

### CROSS-REFERENCE DATA

This is a Continuation-In-Part of international patent application No. PCT/IB01/00354 filed on Mar. 12, 2001 by the present applicant, and claiming the priority of U.S. provisional applications No. 60/214,436 filed on Jun. 28, 2000, No. 60/238,417 filed on Oct. 10, 2000 and No. 60/238,418 filed on Oct. 10, 2000.

### FIELD OF THE INVENTION

The present invention relates to a transaction system and method, and more particularly to a transaction system and method comprising a personal portable identification and transaction control device. One embodiment of the present invention relates to a system and a method for the deferred purchase of a product. Another embodiment of the present invention relates to a system and a method for temporary access to a product by means of a smart card.

### BACKGROUND OF THE INVENTION

It is presently known to accomplish transactions with the help of personal identification devices. These personal identification devices can be, for example, a credit card. These personal identification devices comprise an element which can link the user of the device, to a money or credit account held by this user. Such an element allowing to accomplish this link, is a magnetic strip applied on a plastic card, which comprises a code which is distinctive of the user's account, or an electronic chip comprising such a code distinctive of the user's account.

When a user wishes to accomplish a transaction with a personal identification device for buying a product from a product provider, the transaction is accomplished by means of an interface machine that can debit de user's account, the latter being located by the interface machine thanks to the personal identification device.

Thus, for example, the following steps are accomplished to carry out a conventional transaction applied to the account of a user's credit card upon the purchase of a product from a retailer having an interface machine capable of reading the magnetic strips of credit cards: (a) the amount of the transaction is transmitted to the interface machine in an appropriate manner (by a keyboard provided on the machine, or by the transfer of this information through a link with an electronic cash-register or a computer); (b) the user verifies the amount displayed on the interface machine, and if he accepts the amount of the transaction, then: (c) the retailer employee slides the credit card in the interface machine magnetic strip reader, which then obtains, in a coded form, the identification code associated to the credit card account of the card owner; (d) the interface machine then contacts the financial institution that emitted the card, to verify, with the help of the information concerning the card owner's account, that the client's account is in good order, and while considering the credit limit, the financial institution accepts the transaction, applies it to the client's account, and transmits a transaction confirmation message to the interface machine; (e) the interface machine then prints a paper bill, that indicates to the credit card user that the transaction is approved, and the user signs the bill, to indicate his approval of the transaction amount; two copies of the bill are kept, one for the retailer, the other one for the card owner.

Concerning a transaction with a magnetic strip debit card, the steps are similar to those of a transaction with a credit card, except that the account contacted by the interface machine will be a bank account, and that the money transfer will then be made immediately from the account of the debit card owner, to the account of the retailer. Also, no signature is usually required for the transactions accomplished through the instrumentality of a debit card, but a personal identification number known by the card owner only, must be typed on the keyboard of the interface machine to authorize the transaction. This personal identification number typed on the keyboard of the interface machine is verified by the interface machine, that confirms that it corresponds to the user's personal identification number which is associated to the user's bank account.

In the two above-mentioned cases, it is interesting to note that the card is a simple tool allowing the financial institution, through the instrumentality of the interface machine located at the retailer's, to identify to which account the monetary transaction occurring at the retailer's must be applied. Thus, to the extent where the amount indicated on the display screen of the interface machine is not the same as the amount transferred between the interface machine and the financial institution, frauds are possible, since the card owner does not have any control over the amount which is to be transferred.

### SUMMARY OF THE INVENTION

The present invention relates to a method for a transaction at a point of sales through the instrumentality of a PPITCD comprising the following steps:

a) transmitting the amount of the transaction to said PPITCD;

b) indicating the transaction amount through an interface device of said PPITCD;

c) validating said transaction; and

d) applying said transaction at a financial source associated to said PPITCD.

The present invention also relates to a method according to claim 1, wherein, in step (d), said transaction is applied at a financial source associated to said PPITCD which is not located on said PPITCD according to the following steps:

d1) encoding on said PPITCD the transaction amount with an electronic signature distinctive of said PPITCD;

d2) transmitting the encoded transaction amount from said PPITCD to a financial institution associated to said PPITCD; and

d3) decoding the nature and the amount of the transaction and applying said transaction to an account associated to said PPITCD at said financial institution associated to said PPITCD.

Preferably, said PPITCD is an electronic wallet.

The present invention also relates to a method for an individual who is the owner of a PPITCD to accomplish a transaction at a point of sales through the instrumentality of said PPITCD, said method comprising the following steps:

a) transmitting the amount of the transaction to an interface machine of said point of sales;

b) establishing the communication between said interface machine and said PPITCD;

c) transmitting from said interface machine to said PPITCD the transaction amount;

d) indicating to the owner of said PPITCD the transaction amount through a communication device on said PPITCD;

e) validation of the transaction by the owner of said PPITCD;

f) encoding on said PPITCD the transaction amount with an electronic signature distinctive of said PPITCD;

g) transmitting the encoded transaction amount from said PPITCD to said interface machine;

h) transmitting the encoded transaction amount from said interface machine to a financial institution of the PPITCD owner associated to said PPITCD;

i) decoding the nature and the amount of the transaction at said financial institution of the owner of said PPITCD, and applying the transaction amount to an account of the PPITCD owner; and

j) sending a transaction confirmation message from said financial institution to said interface machine of said point of sales.

Preferably, said PPITCD is a credit smart card.

Preferably, said PPITCD is a debit smart card.

Preferably, the transmission of the transaction amount to said point of sales interface machine in step (a) is accomplished through the instrumentality of a keyboard provided on said interface machine.

Preferably, the communication between the interface machine and the PPITCD in step (b) is established by direct contact between an electronic chip provided on said PPITCD and said interface machine.

Preferably, the communication between the interface machine and the PPITCD in step (b) is established by optical waves between an electronic chip provided on said PPITCD and said interface machine.

Preferably, the communication between the interface machine and the PPITCD in step (b) is established only if a personal identification code is typed on a keyboard provided on said interface machine.

Preferably, the communication to the owner of the PPITCD of the transaction amount in step (d) is accomplished through a display screen provided on said PPITCD that displays the transaction amount, allowing visual inspection of this amount by the owner of said PPITCD.

Preferably, the validation of the transaction by the owner of said PPITCD in step (e) is accomplished by means of a validation button provided on said PPITCD.

Preferably, the validation of the transaction by the owner of said PPITCD in step (e) is accomplished by means of a validation button provided on said interface machine.

Preferably, the validation of the transaction by the owner of said PPITCD in step (e) is accomplished by means of a biometric parameter detector provided on said PPITCD.

Preferably, said biometric parameter detector is a fingerprint detector.

Preferably, the validation of the transaction by the owner of said PPITCD in step (e) is accomplished moreover by means of a validation button provided on said PPITCD.

Preferably, the validation of the transaction by the owner of said PPITCD in step (e) is accomplished through the instrumentality of at least two sequential or simultaneous validation operations.

Preferably, the encoding on the PPITCD of the transaction amount in step (f) is accomplished by means of an electronic signature distinctive of the PPITCD in the form of a cryptographic code.

The present invention also relates to a transaction system at a point of sales through the instrumentality of a PPITCD comprising:

a) means for transmitting the amount of the transaction to said PPITCD;

b) means for indicating the transaction amount through a communication device of said PPITCD;

c) means for validating said transaction; and

d) means for applying said transaction at a financial source associated to said PPITCD.

The present invention also relates to a system according to claim 21, wherein said financial source is not located on said PPITCD, said means for applying said transaction to said financial source associated to said PPITCD comprising:

means for encoding on said PPITCD the transaction amount with an electronic signature distinctive of said PPITCD;

means for transmitting the encoded transaction amount from said PPITCD to a financial institution associated to said PPITCD; and

means for decoding the nature and the amount of the transaction and applying said transaction to an account associated to said PPITCD at said financial institution associated to said PPITCD.

The invention also relates to a system for an individual who is the owner of a PPITCD to accomplish a transaction at a point of sales through the instrumentality of said PPITCD, said system comprising:

a) means for transmitting the amount of the transaction to an interface machine of said point of sales;

b) means for establishing the communication between said interface machine and said PPITCD;

c) means for transmitting from said interface machine to said PPITCD the transaction amount;

d) means for indicating to the owner of said PPITCD the transaction amount through a communication device on said PPITCD;

e) means for the validation of the transaction by the owner of said PPITCD;

f) means for encoding on said PPITCD the transaction amount with an electronic signature distinctive of said PPITCD;

g) means for transmitting the encoded transaction amount from said PPITCD to said interface machine;

h) means for transmitting the encoded transaction amount from said interface machine to a financial institution of the PPITCD owner associated to said PPITCD;

i) means for decoding the nature and the amount of the transaction at said financial institution of the owner of said PPITCD, and for applying of the transaction amount to an account of the PPITCD owner; and

j) means for sending a transaction confirmation message from said financial institution to said interface machine of said point of sales.

The present invention also relates to a method for the deferred purchase of a product by means of a portable transaction device (PTD) that includes an electronic chip, comprising the following steps:

a) establishing the communication between said PTD and a first interface machine;

b) downloading on said PTD, from said first interface machine, a transaction code associated to said product, said PTD saving in memory said transaction code;

c) interrupting the communication between said first interface machine and said PTD;

d) establishing the communication between said PTD and a second interface machine;

e) downloading on said second interface machine, from said PTD, said transaction code associated to said product; and

f) delivering said product associated to said transaction code.

The present invention also relates to a method for the deferred purchase of a product by a client owning a smart card, from a product provider having a terminal, comprising the following steps:

(a) the communication is established between the client's smart card and a first interface machine;

(b) the client selects the product that he wishes to buy on said interface machine;

(c) data associated to the selected product is downloaded from the first interface machine to the product provider's terminal;

(d) the product provider reserves the product selected by the client;

(e) the product provider associates a transaction code to the reserved product;

(f) the product provider's terminal downloads the transaction code to the first interface machine;

(g) the first interface machine downloads the transaction code to the smart card, which saves it in memory;

(h) the communication is interrupted between the smart card and the first interface machine;

(i) the communication is established between the smart card and a point of sales interface machine;

(j) the transaction code is downloaded from the smart card to the point of sales interface machine;

(k) the transaction code is downloaded from the point of sales interface machine to the product provider's terminal;

(l) the product provider associates the reserved product to said transaction code;

(m) the product provider's terminal downloads the data associated to said reserved product to said point of sales interface machine;

(n) the reserved product is remitted to the client from said point of sales;

(o) the communication is interrupted between said point of sales interface machine and said client's smart card; and

(p) the client pays for the product by means of said smart card, either between steps (b) and (h) exclusively, or between steps (j) and (o) exclusively.

Preferably, the method further comprises the following step, between steps (a) and (b):

(a1) said interface machine downloads from said product provider terminal the list of available products.

Preferably, said first interface machine and said point of sales interface machine are one and the same interface machine.

Alternately, said first interface machine and said point of sales interface machine are located physically at different places.

Preferably, said smart card is provided with pre-saved personal data associated to the client, said method further comprising the following steps, between steps (a) and (b):

(a1) said pre-saved personal data on said smart card is downloaded to said first interface machine;

(a2) said personal data is downloaded from said first interface machine to said product provider terminal; and

(a3) said product provider terminal provides to said interface machine a list of products according to the personal data of the client downloaded to said product provider terminal; and wherein, in step (b), the client selects the product that he wishes to buy among said list of products provided by the product provider terminal.

The present invention also relates to a system for the deferred purchase of a product by means of a PPITCD, comprising:

a) means for establishing the communication between said PPITCD and a first interface machine;

b) means for downloading on said PPITCD, from said first interface machine, a transaction code associated to said product, said PPITCD saving in memory said transaction code;

c) means for interrupting the communication between said first interface machine and said PPITCD;

d) means for establishing the communication between said PPITCD and a second interface machine;

e) means for downloading on said second interface machine, from said PPITCD, said transaction code associated to said product; and

f) means for delivering said product associated to said transaction code.

The present invention also relates to a system for the deferred purchase of a product by a client owning a smart card, from a product provider having a terminal, said system comprising:

(a) means for the communication to be established between the client's smart card and a first interface machine;

(b) means for the client to select the product that he wishes to buy on said interface machine;

(c) means for data associated to the selected product to be downloaded from the first interface machine to the product provider's terminal;

(d) means for the product provider to reserve the product selected by the client;

(e) means for the product provider to associate a transaction code to the reserved product;

(f) means for the product provider's terminal to download the transaction code to the first interface machine;

(g) means for the first interface machine to download the transaction code to the smart card, which saves it in memory;

(h) means for the communication to be interrupted between the smart card and the first interface machine;

(i) means for the communication to be established between the smart card and a point of sales interface machine;

(j) means for the transaction code to be downloaded from the smart card to the point of sales interface machine;

(k) means for the transaction code to be downloaded from the point of sales interface machine to the product provider's terminal;

(l) means for the product provider to associate the reserved product to said transaction code;

(m) means for the product provider's terminal downloads the data associated to said reserved product to said point of sales interface machine;

(n) means for the reserved product to be remitted to the client from said point of sales;

(o) means for the communication to be interrupted between said point of sales interface machine and said client's smart card; and

(p) means for the client to pay for the product by means of said smart card.

The present invention also relates to a method for temporary access to a product accessible through an access device, by means of a smart card, comprising the following steps:

a) reserving the product and choosing the temporary access conditions to the product by means of said smart card through a first interface machine;

b) downloading an access code associated to said reserved product and to said temporary access conditions on said smart card, that saves it in memory;

c) downloading said access code to the product from said smart card to a second interface machine capable of controlling said access device;

d) verifying by means of said second interface machine that said temporary access conditions associated to said access code are met, and in the affirmative controlling said access device for it to allow access to said product; and

e) paying for the temporary access to said product at any time after step (a) by means of said smart card.

The present invention also relates to a method for temporary access to a product provider's product and accessible through an access device, by a client owning a smart card, comprising the following steps:

a) the communication is established between the client's smart card and a first interface machine capable of communicating with a product provider's terminal;

b) the client selects the desired product together with the conditions of temporary access to this product on the product provider's terminal through said first interface machine;

c) the product is reserved on said product provider's terminal;

d) the product provider's terminal saves in memory an access code associated to said reserved product and said temporary access conditions associated to said reserved product;

e) the product provider's terminal downloads said access code associated to said product on said smart card, that saves is in memory, through said first interface machine;

f) the communication between said smart card and said first interface machine is interrupted;

g) the communication is established between said smart card and a second interface machine associated to said reserved product, said second interface machine being capable of communicating with said product provider's product terminal and being capable of controlling said access device;

h) said product access code is downloaded from said smart card to said product provider's terminal, through said second interface machine;

i) said product provider verifies that said temporary access conditions associated to said access code are met, and in the affirmative he downloads to said second interface machine an access message;

j) upon receipt of said access message, said second interface machine controls said access device for it to allow access of the client to said product; and

k) the client pays for the temporary access to said product either between steps (b) and (f) exclusively, or after step (g), by means of said smart card.

The present invention also relates to a method for temporary access to a product of a product provider and accessible through an access device, by a client owning a smart card, said method comprising the following steps:

a) the communication is established between said client's smart card and a first interface machine;

b) the communication is established between said first interface machine and a product provider's terminal;

c) the client selects the desired product and temporary access conditions to this product on said first interface machine;

d) the data associated to the selected product and temporary access conditions are downloaded from said first interface machine to said product provider's terminal;

e) the product is indicated as reserved on said product provider's terminal;

f) the product provider's terminal saves in memory said temporary access conditions associated to said reserved product and associates an access code thereto;

g) said product provider's terminal downloads to said first interface machine said access code of the product;

h) said first interface machine downloads said access code of said product to said smart card, which saves it in memory;

i) the communication between said smart card and said first interface machine is interrupted;

j) the communication is established between said smart card and a second interface machine associated to said reserved product;

k) said access code of said product is downloaded from said smart card to said second interface machine;

l) said second interface machine downloads to said product provider's terminal said transaction code;

m) said product provider verifies that said temporary access conditions associated to said access code are met, and in the affirmative downloads to said second interface machine an access message;

n) upon reception of said access message, said second interface machine controls said access device for it to allow access of the client to said product; and

m) the client pays for the temporary access to said product by means of said smart card either between steps (c) and (i) exclusively, or after step (j).

Preferably, said temporary access conditions to said product include an access limited in time.

Preferably, comprising the following step between steps (b) and (c):

(b1) the list of available products of the product provider is downloaded from the product terminal to said first interface machine.

Preferably, step (b1) further includes downloading restrictions to the temporary access conditions associated to said product from said product provider terminal to said first interface machine, and wherein the selection of said temporary access conditions in step (c) are accomplished by considering said restrictions to the temporary access conditions.

The present invention also relates to a system for temporary access to a product accessible through an access device, by means of a smart card, comprising:

a) means for reserving the product and choosing the temporary access conditions to the product by means of said smart card through a first interface machine;

b) means for downloading an access code associated to said reserved product and to said temporary access conditions on said smart card, that saves it in memory;

c) means for downloading said access code to the product from said smart card to a second interface machine capable of controlling said access device;

d) means for verifying by means of said second interface machine that said temporary access conditions associated to said access code are met, and means for, in the affirmative, controlling said access device for it to allow access to said product; and

e) means for paying for the temporary access to said product at any time after step (a) by means of said smart card.

The present invention also relates to a system for temporary access to a product provider's product and accessible through an access device, by a client owning a smart card, comprising the following steps:

a) means for the communication to be established between the client's smart card and a first interface machine capable of communicating a product provider's terminal;

b) means for the client to select the desired product together with the conditions of temporary access to this product on the product provider's terminal through said first interface machine;

c) means for the product to be reserved on said product provider's terminal;

d) means for the product provider's terminal to save in memory an access code associated to said reserved product and said temporary access conditions associated to said reserved product;

e) means for the product provider's terminal to download said access code associated to said product on said smart card, that saves is in memory, through said first interface machine;

f) means for the communication between said smart card and said first interface machine to be interrupted;

g) means for the communication to be established between said smart card and a second interface machine associated to said reserved product, said second interface machine being capable of communicating with said product provider's product terminal and being capable of controlling said access device;

h) means for said product access code to be downloaded from said smart card to said product provider's terminal, through said second interface machine;

i) means for said product provider to verify that said temporary access conditions associated to said access code are met, and means for, in the affirmative, downloading to said second interface machine an access message;

j) means for, upon receipt of said access message, said second interface machine to control said access device for it to allow access of the client to said product; and

k) means for the client to pay for the temporary access to said product either between steps (b) and (f) exclusively, or after step (g), by means of said smart card.

The present invention also relates to a method for temporary access to a product of a product provider and accessible through an access device, by a client owning a smart card, said method comprising the following steps:

a) means for the communication to be established between said client's smart card and a first interface machine;

b) means for the communication to be established between said first interface machine and a product provider's terminal;

c) means for the client to select the desired product and temporary access conditions to this product on said first interface machine;

d) means for the data associated to the selected product and temporary access conditions to be downloaded from said first interface machine to said product provider's terminal;

e) means for the product to be indicated as reserved on said product provider's terminal;

f) means for the product provider's terminal to save in memory said temporary access conditions associated to said reserved product and to associate an access code thereto;

g) means for said product provider's terminal to download to said first interface machine said access code of the product;

h) means for said first interface machine to download said access code of said product to said smart card, which saves it in memory;

i) means for the communication between said smart card and said first interface machine to be interrupted;

j) means for the communication to be established between said smart card and a second interface machine associated to said reserved product;

k) means for said access code of said product to be downloaded from said smart card to said second interface machine;

l) means for said second interface machine to download to said product provider's terminal said transaction code;

m) means for said product provider to verify that said temporary access conditions associated to said access code are met, and in the affirmative to download to said second interface machine an access message;

n) means for, upon reception of said access message, said second interface machine to control said access device for it to allow access of the client to said product; and

m) means for the client to pay for the temporary access to said product by means of said smart card.

The invention also relates to a transaction method with a PPITCD having a communication device, an interface device and an electronic chip linked to said communication device and to said interface device, said method comprising the following steps:

receiving, by download, first data representative of a transaction amount by means of the PPITCD communication device;

indicating said first data through the interface device of said PPITCD;

selectively validating the transaction by means of the interface device of the PPITCD;

encoding on the PPITCD chip said first data with an electronic signature distinctive of said PPITCD, thus forming second data representative of the encoded transaction amount; and

emitting said second data by means of the communication device of said PPITCD.

The invention also relates to a transaction method at an interface machine having a communication device, said method comprising the following steps:

communicating to the interface machine first data representative of a transaction amount;

emitting from the first interface machine said first data, which is destined to be validated and encoded by means of a PPITCD;

receiving by means of said interface machine communication device second data representative of an encoded transaction amount; and

communicating to a financial institution said second data.

The invention also relates to a PPITCD having a communication device, an interface device and an electronic chip linked to said communication device and to said interface device, said PPITCD further comprising:

means for receiving, by download, first data representative of a transaction amount by means of the PPITCD communication device;

means for indicating said first data through the interface device of said PPITCD;

means for selectively validating the transaction by means of the interface device of the PPITCD;

means for encoding on the PPITCD chip said first data with an electronic signature distinctive of said PPITCD, thus forming second data representative of the encoded transaction amount; and

means for emitting said second data by means of the communication device of said PPITCD.

The invention also relates to a transaction method with a PPITCD comprising the following steps:

receiving transaction data on the PPITCD;

indicating said transaction data through an interface device of the PPITCD;

selectively validating the transaction by means of a validation member of the PPITCD;

encoding on the PPITCD said transaction data with an electronic signature distinctive of said PPITCD, thus forming encoded transaction data; and

emitting said encoded transaction data by means of a communication device of the PPITCD.

### BRIEF DESCRIPTION OF THE DRAWINGS

In the annexed drawings:

FIG. 1 is a schematic view of an embodiment of the transaction system according to the present invention;

FIG. 2 is an end elevation of the smart card of FIG. 1;

FIG. 3 is a diagram showing the steps of an embodiment of the transaction method according to the present invention;

FIG. 4 is a schematic view of an embodiment of the system for the deferred purchase of a product according to the present invention;

FIG. 5 is a diagram showing the steps of an embodiment of the method for the deferred purchase of a product according to the present invention;

FIG. 6 is a schematic view of an embodiment of the system for temporary access to a product according to the present invention;

FIG. 7 is a diagram showing the steps of an embodiment of the method for temporary access to a product according to the present invention; and

FIG. 8 is a diagram showing the steps of another embodiment of the method for temporary access to a product according to the present invention.

### DETAILED DESCRIPTION OF THE EMBODIMENTS

A. System and Method to Accomplish a Transaction

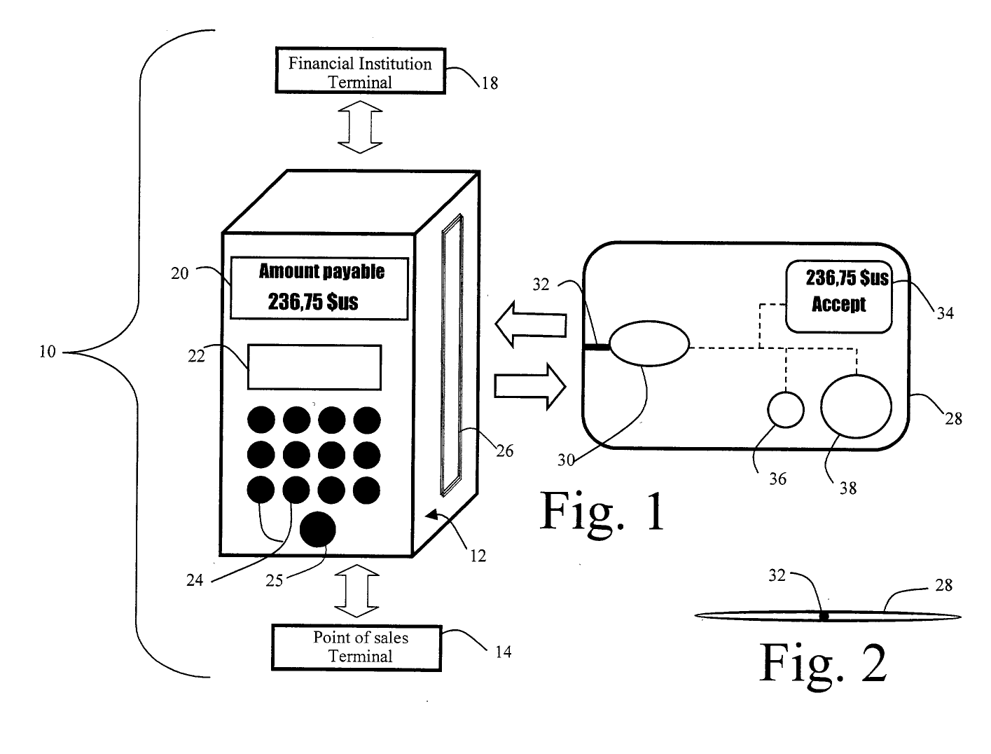

FIG. 1 shows a transaction system 10 according to an embodiment of the present invention. Transaction system 10 comprises an interface machine, which is represented here in the form of a debit machine 12, the latter being linked to a point of sales terminal 14, by a suitable communication system, for example by optical fibers or by a wireless communication system. Terminal 14 can be, for example, an electronic cash register or a computer.

Debit machine 12 is also linked, through a suitable network, for example an optical fiber network or a wireless communication system, to a financial institution terminal 18, for example a bank terminal. This link may be coded according to an encryption system, as it would be obvious to do for someone skilled in the art of data transmission in a confidential manner through the instrumentality of computer systems.

Debit machine 12 is optionally equipped with an interface, comprising for example one or more of the following elements: a display screen 20, an indicator light 22, a keyboard comprising keys 24, and a unique authorization button 25. Debit machine 12 also comprises a communication device 26, which is schematically represented in FIG. 1 in the form of a slot for smart cards, but which may be in any other acceptable known communication form, for example an optical scanner and an optical emitter allowing the reception and emission of information in the form of optical waves.

System 10 moreover comprises a personal portable identification and transaction control device (PPITCD), illustrated in the example of FIG. 1 in the form of a smart card 28, which may have a conventional format. Smart card 28 comprises an electronic chip 30, and a communication device 32 complementary to the communication device 26 of debit machine 12; consequently, if for example communication device 26 of debit machine 12 is an optical emitter and receiver assembly, then communication device 32 of smart card 28 is thus also an optical emitter and receiver assembly capable of communicating with the optical emitters and receivers of the debit machine 12. The communication device of smart card 28 is linked to electronic chip 30.

Smart card 28 comprises moreover an interface device allowing at least the emission of information and linked to electronic chip 30. This interface device of smart card 28 may include a small speaker capable of emitting sound messages; a device capable of emitting Braille messages; or, as illustrated in FIG. 1, may include a display screen 34 also linked to electronic chip 30. Whatever the exact format of the interface device of smart card 28, it must be capable of at least transmitting or communicating information to the card owner. Optionally, the interface device of smart card 28 may moreover comprise one or both of the following elements: a keyboard comprising a single touch button 36 linked to chip 30 or several buttons (not illustrated) linked to chip 30, and a biometric parameter detector such as a fingerprint detector 38 linked to chip 30.

According to the present embodiment of the invention, system 10 is adapted for use during the purchase of a product which may be a ware or a service, at a point of sales, and this by a client. Smart card 28 is the propriety of the client.

According to the transaction method of the present invention with the transaction system 10, the client willing to accomplish a transaction for the purchase of his product, can pay with the help of his debit card 28. To do so, the purchase amount is communicated to the debit machine 12, which then awaits that a communication be established with the client's card. One can note that the purchase amount may be communicated to the debit machine 12 by typing directly thereon the information on its keyboard 24, or alternately this amount may be downloaded to debit machine 12 from point of sales terminal 14.

When the communication is established between smart card 28 and interface machine 12 by means of the complementary communication devices 26 and 32, debit machine 12 transmits to electronic chip 30 of smart card 28, the amount of the transaction. This amount is then indicated to the client, through the instrumentality of the display screen 34 which allows him to visually verify the amount of the transaction on smart card 28. This amount can optionally also be indicated on the display screen 20 of debit machine 12. If the client accepts the amount of the transaction as it is indicated on display screen 34 of smart card 30, he then validates the transaction.

One can note that the validation of the transaction by the client can be accomplished according to at least one, or alternately several, of the following methods: by pressing on the validation button 36 located on card 28, or on an assembly of buttons (not illustrated) located on card 28; by applying his finger on the fingerprint detector 38 located on card 28; by pressing on the validation button 25 located on debit machine 12, or by using a suitable combination of buttons 24 of debit machine 12. Preferably, at least one personal authentication method associated to the client will be used to validate the transaction, for example the detection of a fingerprint or the input of a secret personal identification number (PIN) known by the client only, which is typed either on the keyboard 24 of debit machine 12, or on the buttons (not illustrated) of smart card 28, which can be located directly of the screen if it is in the form of a tactile screen, for example.

Once the transaction is validated, the electronic chip 30 of the debit card encodes the amount of the transaction by means of an electronic signature which will confirm that the amount of the transaction originates effectively from the client's card. The amount of the transaction thus encoded is then conveyed to the financial institution 18 from the debit machine 12, where the client's account is debited of the transaction amount, after this transaction amount has been decoded and the identification of the debit card owner has been confirmed. Afterwards, financial institution 18 can finally send a confirmation to the debit machine 12, to indicate that the client's account has effectively been debited of the transaction amount.

According to the transaction method indicated hereinabove, the client controls himself the amount which will be debited from his account, since his account will be debited of an amount which will have been authorized by the client, and this amount will be encoded with the help of a signature distinctive of the client's card, thus preventing that the amount be modified at the point of sales of the purchased product or between the interface machine and the financial institution.

Transaction system 10 can be applied to a credit rather than a debit transaction. In the case of a credit transaction, a credit smart card is used instead of a debit smart card, and the client's account in the financial institution is an account in a credit company.

The purchase of a product can be made during the transaction by the trade of money currencies, or by other suitable trading units, for example promotional points credited to the purchaser's account.

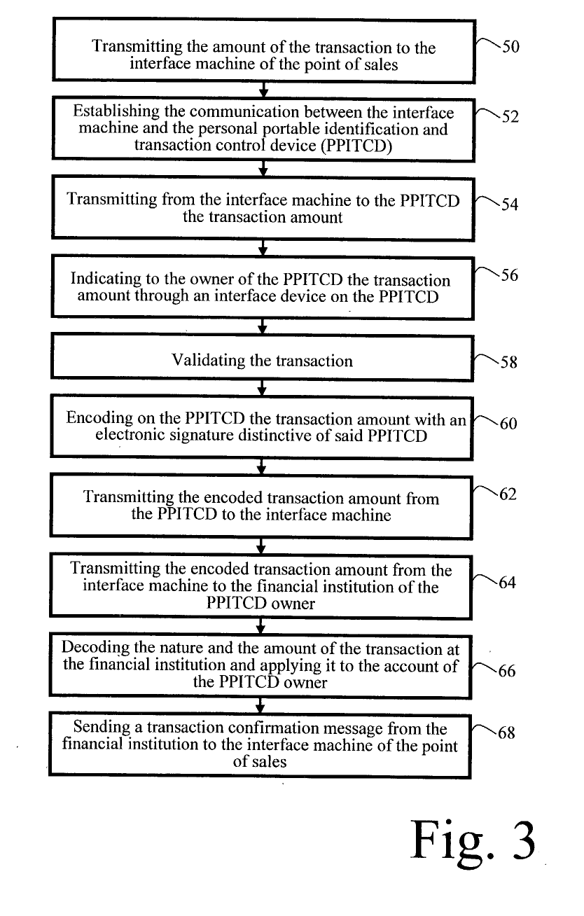

More generally, the method according to the present invention for allowing an individual who is the owner of a personal portable identification and transaction control device (PPITCD) to accomplish a transaction at a point of sales through the instrumentality of his PPITCD comprises the following steps, as illustrated in FIG. 3:

a) transmitting the amount of the transaction to an interface machine of the point of sales (50);

b) establishing the communication between the interface machine and the PPITCD (52);

c) transmitting from the interface machine to the PPITCD the amount of the transaction (54);

d) indicating to the PPITCD owner the amount of the transaction through an interface device of the PPITCD (56);

e) validation of the transaction by the PPITCD owner (58);

f) encoding on the PPITCD the amount of the transaction with an electronic signature distinctive of the PPITCD (60);

g) transmitting the encoded amount of the transaction from the PPITCD to the interface machine (62);

h) transmitting the encoded amount of the transaction from the interface machine to a financial institution of the PPITCD owner associated to the PPITCD (64);

i) decoding the nature and the amount of the transaction at the financial institution of the PPITCD owner, and applying the amount of the transaction to the account of the PPITCD owner (66); and

j) sending a transaction confirmation message by the financial institution to the point of sales interface machine (68).

It is understood that the PPITCD can be any type of credit or debit smart card, or any other portable device including an electronic chip and allowing to accomplish the steps of the method according to the present invention, for example an electronic wallet.

The transmission of the transaction amount to the point of sales interface machine can be accomplished by any type of acceptable transmission. If a keyboard is provided on the interface machine, then the amount may be typed on the keyboard. Alternately, a voice recognition software can be provided in the interface machine, together with an electronic chip, and means for obtaining the voice of a person such as a microphone. Alternately, the amount may be downloaded from the point of sales terminal to the interface machine.

The communication between the interface machine and the PPITCD can be established in any acceptable way, for example by direct contact between an electronic chip provided on the PPITCD and the interface machine, by magnetic waves, by optical waves, or other. According to one embodiment of the invention, it is envisioned that this communication be established only if a personal identification code is typed on the interface machine keyboard 24, or on a keyboard provided on the PPITCD itself (not illustrated). It is also envisioned that another form of authorization be required from the user for the communication to be established between the PPITCD and the interface machine, for example an authorization button located on the PPITCD.

The transaction amount transmission from the interface machine to the PPITCD is accomplished by means of the pre-established link.

The indication to the PPITCD owner of the transaction amount can be accomplished through any suitable communication device provided on the PPITCD. For example, the PPITCD can be provided with the display screen 34 which will display the transaction amount, allowing the visual inspection of this amount by the PPITCD owner. Alternately, the PPITCD can be equipped with a suitable software and with a miniature amplifying system, together with a speaker allowing the PPITCD to transmit to its owner the amount of the transaction through sound waves.

It is also envisioned that the validation of the transaction by the owner of the PPITCD be made according to several different forms. For example, a validation button can be provided on the card, with an electric contact established mechanically when this button is pressed (button 36 in FIG. 1). This validation button may alternately be located on the interface machine (button 25 on FIG. 1). It is also possible that the validation occur only if a personal biometric parameter of the owner is recognized by the PPITCD, the PPITCD then being provided with a biometric parameter detector. For example, is it envisioned to provide a voice recognition software, coupled with a microphone, which will verify that the voice of the PPITCD owner is the right one by sound wave comparison. Alternately, a fingerprint detector 38 can be provided on the PPITCD to allow it to verify the authenticity of the PPITCD owner when the latter applies his finger on detector 38.

The transaction validation by the PPITCD owner can also be accomplished by means of a any combination of two or more validation means. Thus, it is envisioned that the transaction validation be accomplished only if, for example, two fingerprint detectors located on the front and back sides of the card are engaged at the same time by the proper fingers of the PPITCD owner. Or, the validation could be accomplished only if a proper fingerprint is detected, and if a validation button is pressed on the card. The validation button and the fingerprint detector could be located physically at the same place on the card, so that a single application of the PPITCD owner's finger is sufficient.

The encoding on the PPITCD of the transaction amount is accomplished by means of an electronic signature distinctive of the PPITCD. More particularly, this signature can be of several different forms. It is thus envisioned that the signature be a cryptographic code which will make the transaction amount unreadable for anyone except the financial institution that holds the key to the cryptographic code. To this end, it is envisioned for example to use a system of public keys and private keys, where the PPITCD is the unique holder of the private key which allows the encoding of the transaction amounts, and where the financial institution or institutions hold(s) the public keys allowing to decode the received transaction amount. It will be obvious for someone skilled in the art of encoding to determine the most appropriate and most secure way to proceed with encoding the transaction amount on the PPITCD.

The transmission of the encoded transaction amount from the PPITCD to the interface machine is still accomplished through the same link established initially.

The transmission of the encoded transaction amount from the interface machine to the PPITCD owner's financial institution is accomplished according to any type of suitable communication, for example through modems, through wired or wireless communication. It is understood that the PPITCD owner's financial institution is associated to the PPITCD to the extent that an account of the PPITCD owner is associated to the PPITCD and that the financial institution can decode the encoded nature and amount of the transaction. The nature of the transaction refers to the type of transaction that can be accomplished, for example if it is a debit, credit or other transaction. Once the amount is decoded, this amount is applied to the account of the PPITCD owner in an appropriate way according to the nature of the transaction to be applied to the account. The financial institution can be a bank, a credit company, or any other institution where the PPITCD owner owns an account.

The sending of a transaction confirmation message by the financial institution to the point of sales interface machine is accomplished again through the instrumentality of known means, such as a modem or a wireless communication. Once the transaction has been validated by the financial institution, the transaction is completed.

More generally, the transaction method at a point of sales through the instrumentality of a PPITCD can also be defined according to the following steps:

a) transmitting the transaction amount to the PPITCD;

b) indicating the transaction amount through a communication device on the PPITCD;

c) validating the transaction; and

d) applying the transaction to a financial source associated to the PPITCD.

It can indeed be noted that the PPITCD can be a smart card or another device which will communicate with a financial source which is not located on the PPITCD, or alternately the PPITCD can be an electronic wallet or another similar device that will communicate with a financial source that is located on the PPITCD. According to this last option, the PPITCD must be previously loaded with a certain amount of money, as it is known to do for devices of the electronic wallet type. Thus, the transaction is then applied directly to the financial source of the PPITCD which is then located on the electronic chip of the PPITCD.

On the other hand, if the transaction is applied to a financial source associated to the PPITCD which is not located on said PPITCD, this is accomplished according to the following steps:

d1) encoding on the PPITCD the transaction amount with an electronic signature distinctive of the PPITCD;

d2) transmitting the encoded transaction amount from the PPITCD to a financial institution associated to the PPITCD; and

d3) decoding the nature and the amount of the transaction and applying the transaction to an account associated to the PPITCD at the financial institution association to the PPITCD.

B. System and Method for the Deferred Purchase of a Product

According to one embodiment of the present invention, a smart card can be used to buy a product according to a method for the deferred purchase of this product. This smart card can be used as a PPITCD. The method for deferred purchase of a product can be or not be accomplished in combination with the method to accomplish a transaction as described hereinabove.

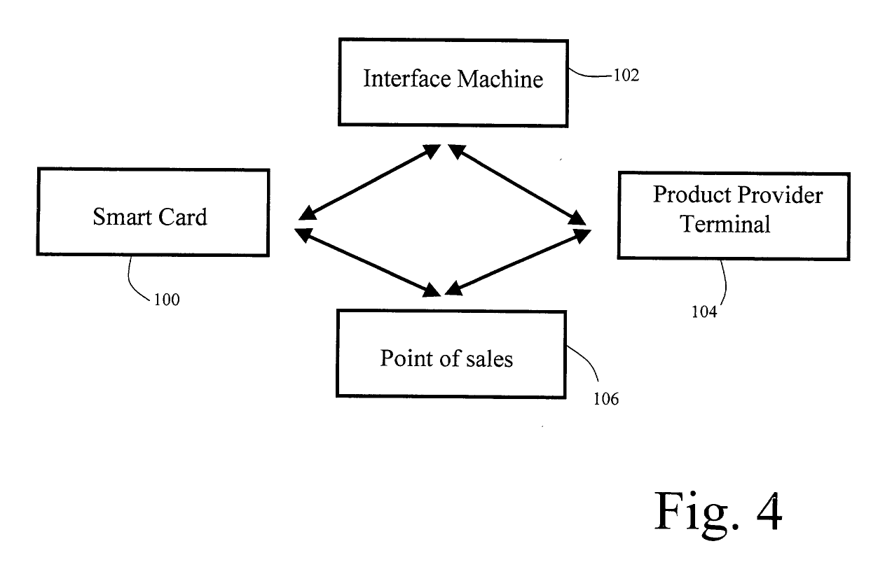

The method for purchasing a product is accomplished in accordance with the diagram of FIG. 4. In a first step, a client owning a smart card 100, which can be a debit card, a credit card or an electronic wallet, establishes contact with a first interface machine 102 by means of his smart card 100, for the purpose of buying a product or another. The product can be a ware, a service, and the term “purchase” includes renting according to the meaning of the present method for the deferred purchase of a product. Known authentication methods, such as those using a personal identification number, can be used to verify the smart card owner's identity.

Once the communication is established between smart card 100 and interface machine 102, the client chooses on interface machine 102 the product that he desires to buy. The list of available products can be located on the interface machine per se, or alternately this product list can be downloaded from a terminal of the provider 104 of this product with which the interface machine can be in communication through known means, for example a modem or a wireless communication. Once the product is selected, the client must indicate that he reserves it, and can pay for this product, according to the product provider's payment policy. Thus, a client account associated to his smart card, for example a bank account, a credit account, or a money account located on the smart card itself (which is then an electronic wallet)—this account, thus, is debited of the amount associated to the purchase of the selected product.

Once the purchase of the product is validated, the data associated to the purchased product is downloaded from first interface machine 102 to the terminal of the product provider 104, and this product is suitably indicated in the data bank of the product provider as being reserved. The terminal of the product provider 104 then associates a transaction code to this purchased product, and this transaction code is saved in association with the product on the terminal of the product provider 104, and this code is also downloaded to interface machine 102, then on smart card 100 from interface machine 102. The transaction code is saved and kept in memory by smart card 102.

It is noted that the intervention of the product provider can be automated to the extent that the terminal of the product provider 104 would be equipped with a suitable software, i.e. that the terminal equipped with this suitable software can provide a list of available products to the interface machine, receive a product reservation order, indicate the product as reserved in the inventory of the product provider's terminal, associate a transaction code to the product, and then download this transaction code to the interface machine, without human intervention. Alternately, an individual interacting with the terminal of the product provider 104 can manually control the terminal 104 so that the relevant steps be accomplished.

It is envisioned, in accordance with an option of the present invention, that a certain quantity of personal data be pre-saved on the smart card. This personal data is of course distinctive of the card owner, and can include, non-exclusively: the name of the owner, his address, his phone number, his preferences concerning certain particular products, etc . . . This personal data may be downloaded from the smart card to the interface machine 102, and then to the terminal of the product provider 104, to be saved therein until the product is delivered.

Once the transaction code is received by smart card 100, the reservation and the purchase of the product are completed, and the communication between smart card 100 and first interface machine 102 is interrupted.

Later on, when the client wishes to take possession of the reserved and purchased product, he establishes the communication between his smart card and a point of sales interface machine 106, where the reserved product may be delivered. The transaction code pre-saved on the smart card is then downloaded from smart card 100 to the point of sales interface machine 106, and then from the latter to the product provider 104, who then associates the purchased product to the transaction code. The product provider then downloads the data concerning the reserved product to the point of sales interface machine 106, and the product is suitably delivered to the client, either manually or automatically. The communication between smart card 100 and the point of sales interface machine is then interrupted.

It is possible, according to the product provider's policy, to pay for the product only at the time of delivery thereof, rather than at the time of its reservation, or at any other time which is considered to be appropriate by the product provider, either during the product reservation phase, or during the product delivery phase, or when the product is returned (for example if we are in the case of a rental).

Moreover, it is also possible that the first interface machine 102 be the same as the point of sales interface machine 106.

For example, this method for the deferred purchase of a product can be applied to the purchase of a plane ticket. The steps followed in this example are the following:

(a) the client establishes the communication between his smart card and an automatic teller (which is the first interface machine);

(b) the client chooses the desired plane ticket at the automatic teller;

(c) data associated to the purchased product is downloaded from the automatic teller to the product provider, where the ticket is reserved for the client, and where a transaction code is associated to the plane ticket;

(d) the transaction code is downloaded from the airline terminal to the automatic teller, then from the automatic teller onto the smart card, where it is saved in memory;

(e) the client account is debited of the amount associated to the plane ticket purchase according to a known method;

(f) the communication is interrupted between the automatic teller and the smart card;

(g) the day of the flight, the client goes to the airport and establishes the communication between his smart card and the machine that issues plane tickets;

(h) the transaction code associated to the purchase of the plane ticket is downloaded from the smart card to the machine that issues plane tickets;

(i) the transaction code is then downloaded from the machine that issues plane tickets to the airline terminal, which then associates the reserved plane ticket to this transaction code;

(j) the airline terminal then downloads the data associated to the ticket reserved by the client, to the machine that issues plane tickets;

(k) the machine that issues plane tickets prints and delivers the plane ticket to the client, or alternately the access to the plane is immediately granted to the client;

(l) the client retrieves his smart card, interrupting the communication with the machine that issues plane tickets.

According to one embodiment of the invention, personal data of the client is pre-saved on his smart card, for ulterior use during the deferred purchase of the product as described hereinabove. This data may include his name, his address information, and his preferences. For example, in the above example, the personal data of the client may include his name, his address, his plane seat positioning preferences, his food allergies if he has any, his preferences concerning times of the day for departures, etc . . .

Consequently, when the client chooses a plane ticket, the automatic teller can have already obtained from the client's smart card his personal data, so that only the tickets corresponding to his preferences be offered to him. The client then selects the desired product among the list of available products which correspond to his pre-saved preferences. Moreover, the client does not have to provide information concerning his personal information, which is also downloaded from the smart card to the interface machine, such as his address, etc . . .

It is understood that the transaction code could be kept during an indeterminate or determined time period on the smart card, for ulterior access by means of the smart card to the product of the product provider.

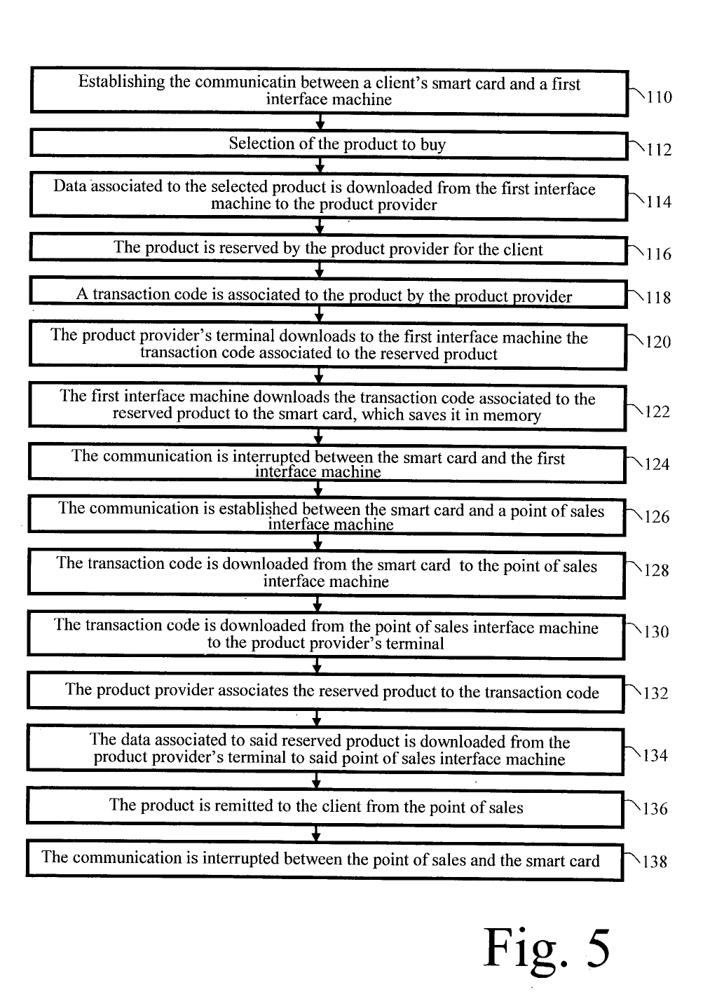

More generally, the method for the deferred purchase of a product comprises the following steps, as illustrated in FIG. 5:

(a) the communication is established between the client's smart card and a first interface machine (110);

(b) the client selects the product that he wishes to buy (112);

(c) data associated to the selected product is downloaded from the first interface machine to the product provider's terminal (114);

(d) the product provider reserves the product selected by the client (116);

(e) the product provider associates a transaction code to the reserved product (118);

(f) the product provider's terminal downloads the transaction code to the first interface machine (120);

(g) the first interface machine downloads the transaction code to the smart card, which saves it in memory (122);

(h) the communication is interrupted between the smart card and the first interface machine (124);

(i) the communication is established between the smart card and a point of sales interface machine (126);

(j) the transaction code is downloaded from the smart card to the point of sales interface machine (128);

(k) the transaction code is downloaded from the point of sales interface machine to the product provider's terminal (130);

(l) the product provider associates the reserved product to the transaction code (132);

(m) the product provider's terminal downloads the data associated to the reserved product to the point of sales interface machine (134);

(n) the reserved product is remitted to the client from the point of sales (136);

(o) the communication is interrupted between the point of sales interface machine and the client's smart card (138); and

(p) the client pays for the product by means of his smart card, either between steps (b) and (h) exclusively, or between steps (j) and (o) exclusively.

The method foe the deferred purchase of a product can be accomplished by means of a portable transaction device (PTD) which includes an electronic chip, such as for example a smart card or an electronic wallet, and comprises the following steps:

a) establishing the communication between the PTD and a first interface machine;

b) downloading on the PTD, from the first interface machine, a transaction code associated to the product, the PTD saving in memory the transaction code;

c) interrupting the communication between the PTD and the first interface machine;

d) establishing the communication between the PTD and a second interface machine;

e) downloading on the second interface machine, from the PTD, the transaction code associated to the product; and

delivering the product associated to the transaction code.

C. System and Method for Temporary Access to a Product by Means of a Smart Card

According to another embodiment of the present invention, a smart card, which may also be used in accordance with the transaction method described hereinabove, which can be or not be a PPITCD, and which may also be used or not in accordance with the method for the deferred purchase of a product described hereinabove, can be used within the framework of a system and a method for temporary access to a product by means of this smart card.

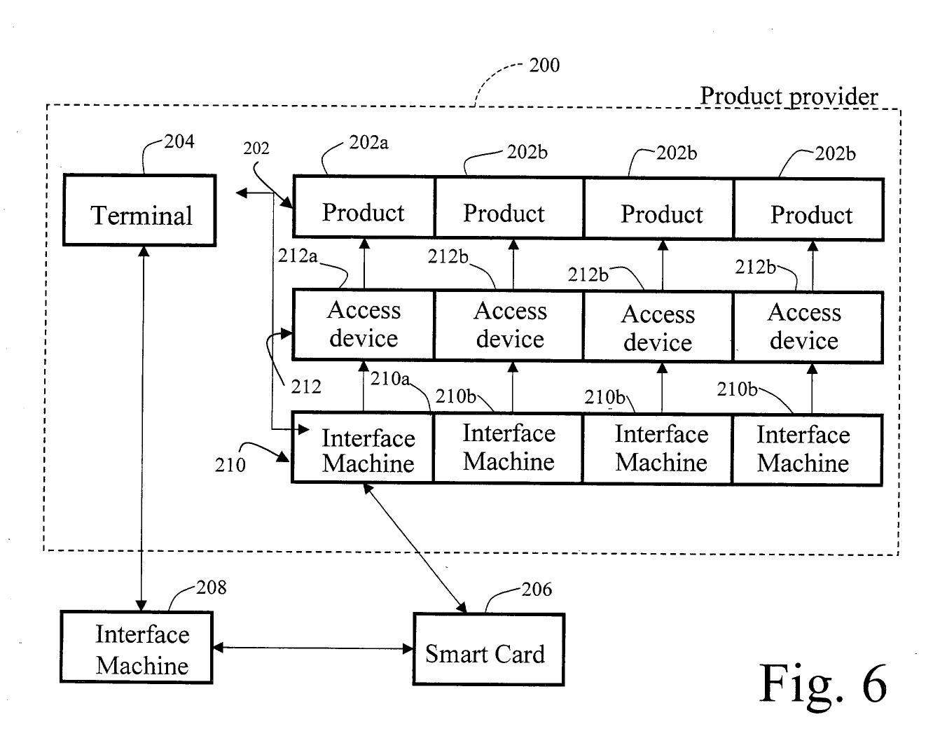

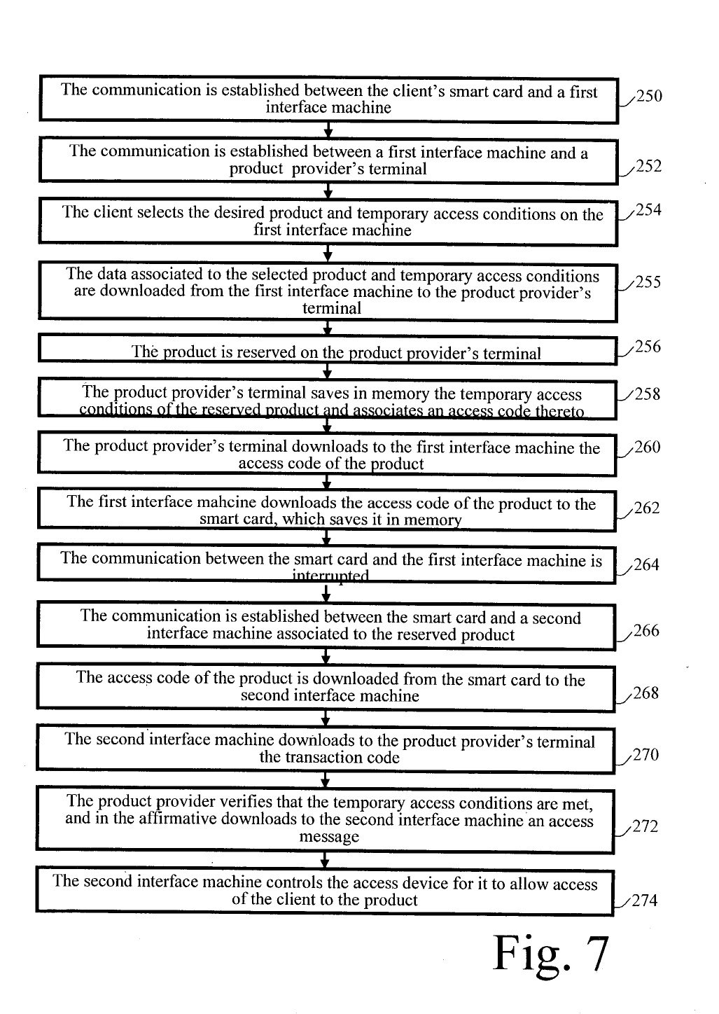

FIG. 6 schematically illustrates the system and the method for temporary access to a product according to the present invention. There is shown a product provider 200 that offers a certain number of products 202 for rent, for a limited time period. These products can be wares or services, for example vehicles for rent or lodgings for rent. All these products are linked in a suitable manner to a terminal 204 of the product provider, either in a permanent fashion, or in a punctual fashion.

A user can have access to one or several of the products of the product provider through the instrumentality of a smart card 206. Smart card 206 can be for example a debit smart card, a credit smart card, or an electronic wallet. A client can establish the communication between his smart card 206 and a suitable interface machine 208, in a known manner. Through this interface machine 208, the client can obtain from the terminal 204 of the product provider 200, the list of the available products 202, and select one or more products 202a among the available products 202.

Once a product 202a is selected, the product provider reserves the product 202a for a determined period of time, in accordance with the client's demand. An access code is then downloaded from terminal 204 of the product provider 200, to interface machine 208, and then to smart card 206, where the access code is saved in the memory of the smart card. At the same time, instructions concerning the access instructions to the product 202a selected by the client are downloaded from the product provider terminal 204 to an interface machine 210a associated to the product 202a selected by the client. The link between the smart card 206 and the interface machine 208 can then be interrupted.

When the client wishes to take possession of the selected product 202a for the period of time allowed to him for product 202a, he establishes the communication in a known fashion between his smart card 206 and the interface machine 210a associated to product 202a. The interface machine 210a then downloads from smart card 206 the access code which has been saved, and verifies that the code together with the rental conditions for product 202a, correspond indeed to the instructions received from terminal 204. In the affirmative, the access to product 202a is granted, through an access device 212a associated to product 202a. In the negative, access to product 202a is refused. Thus, a client may gain access to product 202a of product provider 200, without however gaining access to the other non-reserved products 202b since the access conditions which would be verified by the interface machines 210b of the non-reserved products 202b would not be met. The access device 212b would then not allow access to product 202b to which the client is not allowed to have access according to the rental conditions which he has established with the product provider 200.

The access devices 212a, 212b, generally referred to with numeral 212, can be an electrically controlled lock, or any other device allowing a selected access of the client to the product, as long as the access conditions are met when a communication is established between the client's smart card and interface machines 210 associated to products 202.

According to one embodiment of the present invention, the instructions concerning the access conditions to product 202a selected by the client, are not downloaded from terminal 204 to interface machine 210a associated to product 202a, but are rather kept in memory in the product provider terminal. When a communication link is established between smart card 206 and interface machine 210a associated to product 202a by the client who wishes to gain access to product 202a, the interface machine then communicates with terminal 204, and downloads the access code from the smart card to convey it to terminal 204. Terminal 204 then associates the access code to the access conditions to the product, and if the conditions are met, a message allowing access is then downloaded from terminal 204 to interface machine 210a, that then orders the access device 212a to allow access to product 202a.

A concrete, although non exclusive, example of the system and the method of an access key with a smart card according to the present invention, will now be explained.

A client wishes to rent a hotel room for two nights. Using his smart card, he inserts it in an automatic teller that contacts the hotel terminal where he wishes to obtain a room. He chooses his room, according to his preferences (that can be pre-saved in the form of personal data in the memory of the smart card), and reserves the room for the two nights he desires. The hotel terminal downloads on the card an access code, and keeps in memory the access instructions associated to the access code. In the case at hand, the access instructions are to let the access code owner enter the appropriate room during the time period during which this room has been rented. More specifically, to let the access code owner enter in the appropriate room means that the electronic lock of the door leading to the reserved room must be unlockable during the two day rental period of the room by the client, when a communication link is established between the card having the appropriate access code and the interface machine controlling the above-mentioned lock.

The link between the automatic teller and the smart card can then be interrupted.

When the client arrives at the hotel for his stay, he can thus have access inside the hotel, and inside his room, by means of the access code which is saved on his card, for the duration of the time period during which his hotel room has been rented. More specifically, the client establishes the communication between his smart card and the interface machine controlling the lock of his reserved hotel room. Then, the interface machine downloads the access code from the client's smart card, and conveys it to the hotel terminal. The terminal then compares the access conditions with the downloaded code. More specifically, this comparison is accomplished as follows: the access code allows the data associated to the to the room rental to be recuperated, namely during which period the access to the room is granted, and which room it is precisely. Thus, the hotel terminal verifies that the room is indeed the one that has been reserved, and that the time at which access is desired in this room falls within the period during which the room is reserved. If all the conditions are met, then the terminal downloads to the rented room interface machine a right of access message, which will result in the interface machine of the rented room controlling the lock of the door to unlock it. The client will thus have access to his reserved room by means of his smart card.

The payment for the rental of products 202 can be accomplished at any time, according to the product provider's payment policy. Thus, it is envisioned that the payment be accomplished initially when product 202a is reserved, through interface machine 208 which is external to the product provider. Alternately, the payment can be accomplished once the rental of product 202a is completed, or in real time if interface machine 210a associated to product 202a is continuously in contact with smart card 206.

The method for temporary access to a product of a product provider and accessible through an access device, by a client owning a smart card, can be defined according to the following steps, as illustrated in FIG. 7:

a) the communication is established between the client's smart card and a first interface machine (250);

b) the communication is established between the first interface machine and a product provider's terminal (252);

c) the client selects the product which is desired and the conditions of temporary access to this product on the first interface machine (254);

d) the data associated to the selected product and conditions of temporary access to this product are downloaded from the first interface machine to the product provider's terminal (255);

e) the product is indicated as reserved on the product provider's terminal (256);

f) the product provider's terminal saves in memory the temporary access conditions associated to the reserved product and associates an access code thereto (258);

g) the product provider's terminal downloads to the first interface machine the code of access to the product (260);

h) the first interface machine downloads the code of access to the product to the smart card, which saves it in memory (262);

i) the communication between the smart card and the first interface machine is interrupted (264);

j) the communication is established between the smart card and a second interface machine associated to the reserved product (266);

k) the code of access to the product is downloaded from the smart card to the second interface machine (268);

l) the second interface machine downloads to the product provider's terminal the transaction code (270);

m) the product provider verifies that the temporary access conditions are met, and in the affirmative downloads to the second interface machine an access message (272);

n) the second interface machine controls the access device for it to allow access of the client to the product (274); and

m) the client pays for the temporary access to the product by means of his smart card either between steps (c) and (i) exclusively, or after step (j).

The conditions of access to the product can be of several types, but always imply that the access code must be located on the smart card to allow access to the product. Examples of conditions of access can be an access limited in time, either a particular time interval, or a total time availability of the product; or an access limited by the use of the product, for example a car to which access is allowed for a certain number of kilometers. It is also envisioned to have conditions of access which depend on the credit availability on the smart card. All other acceptable conditions of temporary access to a product can also be envisioned.

Concerning the selection of the product in step (c), it is envisioned to accomplish this from a list of products already located on the first interface machine, or alternately that the product list be previously downloaded on the first interface machine from the product provider's terminal. The client must also choose the conditions of temporary access to the product that he wishes to obtain. It is understood that these conditions of temporary access can be subject to restrictions according to the product provider's policy, and the client can consequently choose the conditions of temporary access according to the freedom that is offered by the product provider in this respect.

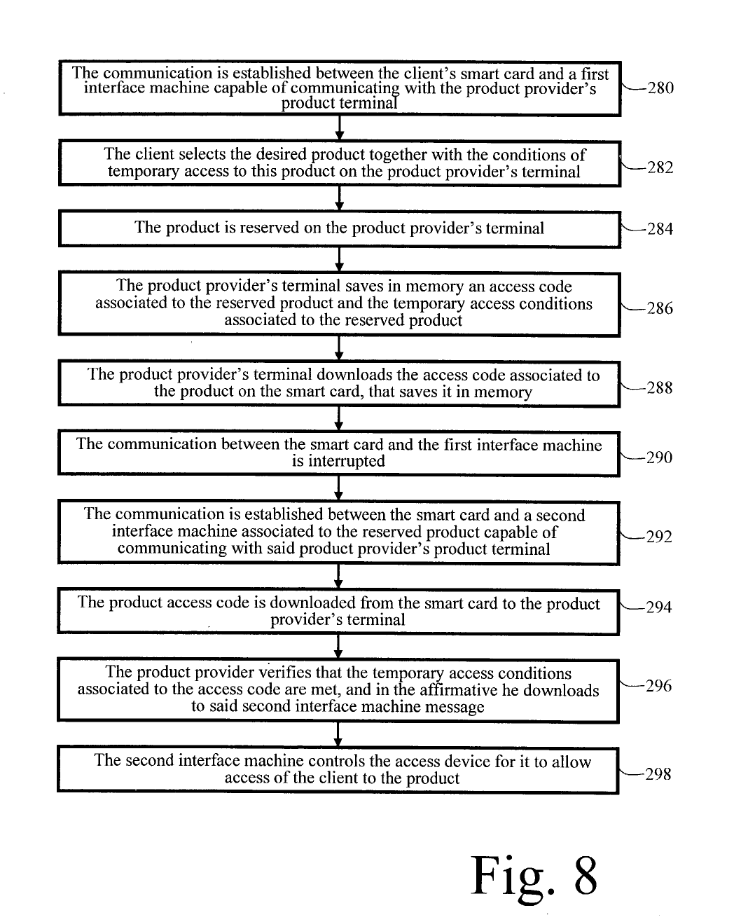

More briefly, the method of temporary access to a product provider's product and accessible through an access device, by a client owning a smart card, can be summarized as follows, as illustrated in FIG. 8:

a) the communication is established between the client's smart card and a first interface machine capable of communicating with the product provider's product terminal (280);

b) the client selects the desired product together with the conditions of temporary access to this product on the product provider's terminal (282);

c) the product is reserved on the product provider's terminal (284);

d) the product provider's terminal saves in memory an access code associated to the reserved product and temporary access conditions associated to the reserved product (286);

e) the product provider's terminal downloads the access code associated to the product to the smart card, that saves is in memory (288);

f) the communication between the smart card and the first interface machine is interrupted (290);

g) the communication is established between the smart card and a second interface machine associated to the reserved product and capable of communicating with the product provider's product terminal (292);

h) the product access code is downloaded from the smart card to the product provider's terminal (294);

i) the product provider verifies that the temporary access conditions associated to the access code are met, and in the affirmative he downloads to the second interface machine an access message (296);

j) upon receipt of the access message, the second interface machine controls the access device for it to allow access of the client to the product (298); and

k) the client pays for the temporary access to the product either between steps (b) and (f) exclusively, or after step (g).

More generally, the present method for temporary access to a product accessible through an access device, by a client owning a smart card, can be defined according to the following steps:

a) the client reserves the product and chooses the temporary access conditions by means of said smart card through a first interface machine;

b) an access code associated to said reserved product and to said temporary access conditions is downloaded on said smart card, that saves it in memory;

c) said code of access to the product is downloaded from said smart card to a second interface machine capable of controlling said access device;

d) said second interface machine verifies that said temporary access conditions associated to said access code are met, and in the affirmative controls said access device for it to allow access of the client to said product; and

e) the client pays for the temporary access to said product after step (a) by means of said smart card.

It is noted that in the different embodiments of the present invention, it is envisioned that the PPITCD, the PTD or the smart card keeps in its memory all the transactions that are accomplished.

1. A method for a transaction at a point of sales through the instrumentality of a PPITCD comprising the following steps:
a) transmitting the amount of the transaction to said PPITCD;
b) indicating the transaction amount through an interface device of said PPITCD;
c) validating said transaction; and
d) applying said transaction at a financial source associated to said PPITCD.

2. The method according to claim 1, wherein, in step (d), said transaction is applied at a financial source associated to said PPITCD which is not located on said PPITCD according to the following steps:
d1) encoding on said PPITCD the transaction amount with an electronic signature distinctive of said PPITCD;
d2) transmitting the encoded transaction amount from said PPITCD to a financial institution associated to said PPITCD; and
d3) decoding the nature and the amount of the transaction and applying said transaction to an account associated to said PPITCD at said financial institution associated to said PPITCD.

3. The method according to claim 2, wherein in step (c), said transaction is validated by means the interface device of the PPITCD.

4. The method according to claim 1, wherein in step (d), said transaction is directly applied to a financial source associated to said PPITCD which is located on said PPITCD, said PPITCD being an electronic wallet.

5. A method for an individual who is the owner of a PPITCD to accomplish a transaction at a point of sales through the instrumentality of said PPITCD, said method comprising the following steps:
a) transmitting the amount of the transaction to an interface machine of said point of sales;
b) establishing the communication between said interface machine and said PPITCD;
c) transmitting from said interface machine to said PPITCD the transaction amount;
d) indicating to the owner of said PPITCD the transaction amount through an interface device on said PPITCD;
e) selectively validating the transaction;
f) encoding on said PPITCD the transaction amount with an electronic signature distinctive of said PPITCD;
g) transmitting the encoded transaction amount from said PPITCD to said interface machine;
h) transmitting the encoded transaction amount from said interface machine to a financial institution of the PPITCD owner associated to said PPITCD;
i) decoding the nature and the amount of the transaction at said financial institution of the owner of said PPITCD, and applying the transaction amount to an account of the PPITCD owner; and
j) sending a transaction confirmation message from said financial institution to said interface machine of said point of sales.

6. The method according to claim 5, wherein the transmission of the transaction amount to said point of sales interface machine in step (a) is accomplished through the instrumentality of a keyboard provided on said interface machine.

7. The method according to claim 5, wherein the communication between the interface machine and the PPITCD in step (b) is established by optical waves between a first communication device linked to an electronic chip and provided on said PPITCD, and a second communication device provided on said interface machine.

8. The method according to claim 5, wherein the communication between the interface machine and the PPITCD in step (b) is established only if a personal identification code is typed on a keyboard provided on said interface machine.

9. The method according to claim 5, wherein the communication to the owner of the PPITCD of the transaction amount in step (d) is accomplished through a display screen provided on said PPITCD that displays the transaction amount, allowing visual inspection of this amount by the owner of said PPITCD.

10. The method according to claim 5, wherein the validation of the transaction by the owner of said PPITCD in step (e) is accomplished by means of a validation button provided on said PPITCD.

11. The method according to claim 5, wherein the validation of the transaction by the owner of said PPITCD in step (e) is accomplished by means of a biometric parameter detector provided on said PPITCD.

12. The method according to claim 11, wherein said biometric parameter detector is a fingerprint detector.

13. The method according to claim 11, wherein the validation of the transaction by the owner of said PPITCD in step (e) is accomplished moreover by means of a validation button provided on said PPITCD.

14. The method according to claim 5, wherein the validation of the transaction by the owner of said PPITCD in step (e) is accomplished through the instrumentality of at least two sequential or simultaneous validation operations.

15. The method according to claim 5, wherein the encoding on the PPITCD of the transaction amount in step (f) is accomplished by means of an electronic signature distinctive of the PPITCD in the form of a cryptographic code.

16. A transaction method with a PPITCD having a communication device, an interface device and an electronic chip linked to said communication device and to said interface device, said method comprising the following steps:
receiving, by download, first data representative of a transaction amount by means of the PPITCD communication device;
indicating said first data through the interface device of said PPITCD;
selectively validating the transaction by means of the interface device of the PPITCD;
encoding on the PPITCD chip said first data with an electronic signature distinctive of said PPITCD, thus forming second data representative of the encoded transaction amount; and
emitting said second data by means of the communication device of said PPITCD.

17. A transaction method at an interface machine having a communication device, said method comprising the following steps:
communicating to the interface machine first data representative of a transaction amount;
emitting from the first interface machine said first data, which is destined to be validated and encoded by means of a PPITCD;
receiving by means of said interface machine communication device second data representative of an encoded transaction amount; and
communicating to a financial institution said second data.

18. A PPITCD having a communication device, an interface device and an electronic chip linked to said communication device and to said interface device, said PPITCD further comprising:
means for receiving, by download, first data representative of a transaction amount by means of the PPITCD communication device;
means for indicating said first data through the interface device of said PPITCD;
means for selectively validating the transaction by means of the interface device of the PPITCD;
means for encoding on the PPITCD chip said first data with an electronic signature distinctive of said PPITCD, thus forming second data representative of the encoded transaction amount; and
means for emitting said second data by means of the communication device of said PPITCD.

19. A transaction method with a PPITCD comprising the following steps:
receiving transaction data on the PPITCD;
indicating said transaction data through an interface device of the PPITCD;
selectively validating the transaction by means of a validation member of the PPITCD;
encoding on the PPITCD said transaction data with an electronic signature distinctive of said PPITCD, thus forming encoded transaction data; and
emitting said encoded transaction data by means of a communication device of the PPITCD.
